(19) United States
(12) Patent Application Publication
(10) Pub. No.: US 2017/0028795 A1
(43) Pub. Date: Feb. 2, 2017

(54) INDICATION OF VEHICLE STATUS USING LIGHT

(71) Applicant: GM GLOBAL TECHNOLOGY OPERATIONS LLC, Detroit, MI (US)

(72) Inventor: Eric E. Schlaupitz, Rochester Hills, MI (US)

(73) Assignee: GM GLOBAL TECHNOLOGY OPERATIONS LLC, Detroit, MI (US)

(21) Appl. No.: 14/811,053

(22) Filed: Jul. 28, 2015

(51) Int. Cl. B60C 23/04

(52) U.S. Cl. CPC B60C 23/0406

(57) ABSTRACT

A vehicle includes a powertrain, body, component, tire, lighting device, sensor, and controller. The lighting device is positioned with respect to the body or component, which is connected to the body, and illuminates in response to an output signal in a manner corresponding to a status of the vehicle. The sensor determines the status. The controller executes a method to receive, from a remote device, a proximity signal indicative of an operator of the vehicle being within range of the vehicle, and receives an input signal from the sensor indicative of the status of the vehicle. The status includes an ignition status and/or a low tire pressure status. The controller transmits the output signal to the lighting device in response to both the received input signal and the proximity signal to command illumination of the lighting device to thereby display the status of the vehicle.

### TECHNICAL FIELD

The disclosure relates to the indication of a vehicle status using light.

### BACKGROUND

Vehicles include a body having one or more doors. In some designs, the doors can be remotely locked and unlocked, such as via radio frequency signals using a keyless entry device. When an operator remotely locks the vehicle's doors, successful completion of the locking sequence is typically communicated to the operator by a brief sounding of the vehicle's horn or flashing of existing exterior lights, accompanied by the movement of mechanical locking pins or illumination of a lock pin light. Additionally, lamps or status lights may be displayed on an instrument panel or dashboard. However, as operators may not be present within or in close proximity to the vehicle, the effectiveness of conventional approaches for communicating the status of a given vehicle system may be limited.

### SUMMARY

A vehicle is disclosed that, in an example configuration, includes a powertrain, a body, a tire, a lighting device, a sensor, and a controller. The lighting device illuminates in response to an output signal in a manner corresponding to a status of the vehicle, with the status determined by the sensor. The controller has a processor and memory on which is recorded instructions for indicating the status of the vehicle via the lighting device. Execution of the instructions by the processor causes the controller to receive, from a remote device, a proximity signal indicative of an operator of the vehicle being within a predetermined range of the vehicle. The controller also receives an input signal from the sensor indicative of the status of the vehicle, including at least one, and possibly both, of an on/off ignition status of the powertrain and a low pressure status of the tire. The controller also transmits the output signal to the lighting device in response to both the received input signal and the proximity signal to thereby command an illumination of the lighting device.

The lighting device may be positioned with respect to a door in a possible embodiment. The door may include a door handle as the component. In such a design, the lighting device may be positioned on, within, or adjacent to the door handle. The component may be alternatively embodied as a side mirror assembly, with the lighting device positioned on, within, or adjacent to the side mirror assembly.

The above features and advantages and other features and advantages of the present disclosure are readily apparent from the following detailed description of the best modes for carrying out the disclosure when read in conjunction 160 with the accompanying drawings.

### BRIEF DESCRIPTION OF THE DRAWINGS

FIG. 1 is a schematic illustration of an example vehicle having a controller and one or more lighting devices, with the controller programmed to selectively illuminate the lighting device(s) to indicate a status of the vehicle as set forth herein.

FIGS. 2A-B are schematic perspective view illustrations of example door handle-integrated lighting device embodiments usable with the vehicle of FIG. 1.

FIG. 3 is a flow chart depicting an example method for indicating a vehicle status using light.

### DETAILED DESCRIPTION

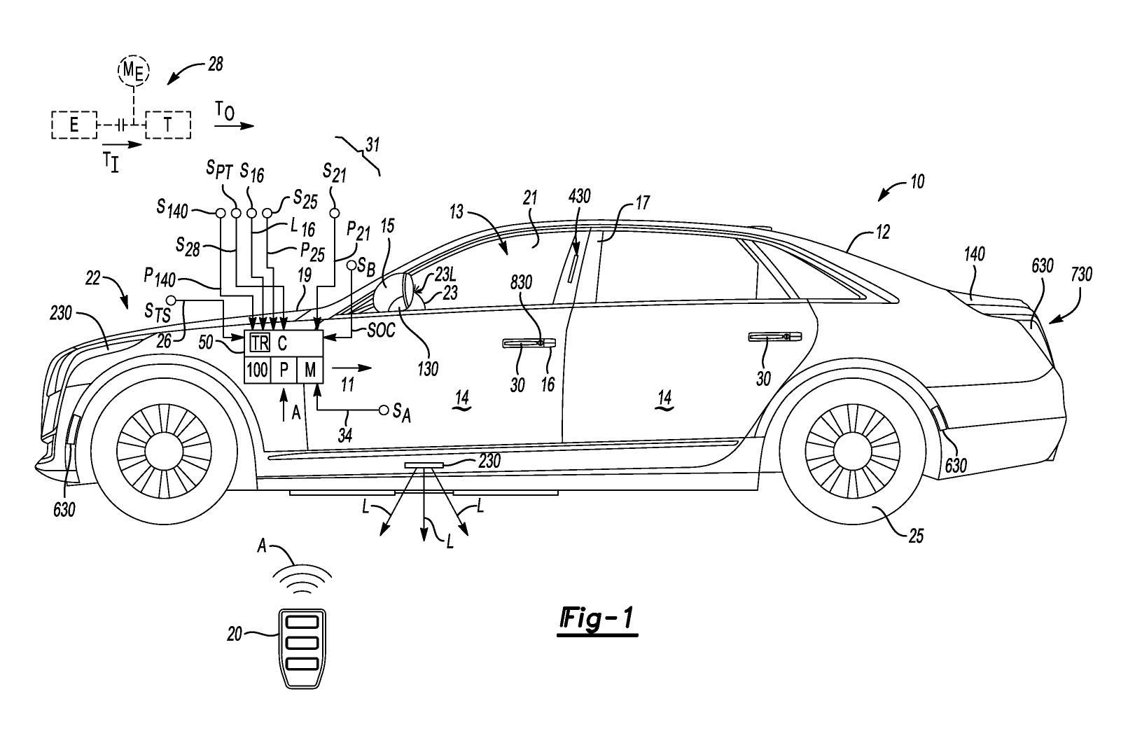

Referring to the Figures, wherein like numerals indicate like parts throughout the several views, an example vehicle 10 is depicted in FIG. 1. One of ordinary skill in the art will appreciate that non-automotive vehicle applications may be envisioned within the intended inventive scope, e.g., aircraft, boats, trains, etc., as well as non-vehicular applications such as buildings, appliances, and the like. For illustrative consistency, the vehicle 10 will be described hereinafter in an automotive vehicular context without limiting the possible scope of the disclosure to such an embodiment.

The vehicle 10 includes a body 12 constructed of sheet metal or other suitable materials defining a passenger compartment 13. The body 12 includes doors 14 with windows 21, with the doors 14 latched/locked and unlatched/unlocked via a component in the form of a door handle 16. The body 12 may also include a trunk lid 140 and a hood 19. One or more additional components 15, shown as an example side mirror assembly, may be positioned with respect to the body 12. The body 12 may also include an A-pillar 17 for structural support of the body 12, as is well known in the art.

A controller (C) 50 is included as part of the present design. The controller 50 includes a processor (P) and memory (M) on which is recorded instructions embodying a method 100 for indicating a status of the vehicle 10. Status is indicated via automatic control of a lighting device 30 and/or one of its alternative embodiments. Execution of the instructions by the processor (P) causes the controller 50 to receive, from a remote device 20 such as a key fob or cell phone, proximity signals (A) indicating close proximity of the remote device 20 to the vehicle 10, with the term “close proximity” referring to the remote device 20 being within a predetermined communications range, usually about 20-30 meters for typical 315 kHz-433.92 kHz RF keyless entry device. When higher-frequency RF devices are used, such as a cell phone or portable device having BLUETOOTH or other suitable communications protocol functionality, the range may be shorter or longer, such as the effective 10 meter range currently enabled by the 2.4 GHz-2.485 GHz industrial, scientific and medical (ISM) band. Optionally, the detection of the remote device 20 may be indicated via the lighting device 20, e.g., via a lighting sequence, to indicate the vehicle 10 is in range, which may also help to locate the vehicle 10 in a parking lot.

The controller 50 is also programmed to transmit an output signal (arrow 11) to the lighting device 30 and/or any of its alternative embodiments described below in response to the proximity signal (A), i.e., only when the remote device 20 is located within the predetermined range of the vehicle 10, to thereby command illumination of the lighting device 30 in a manner corresponding to the determined status.

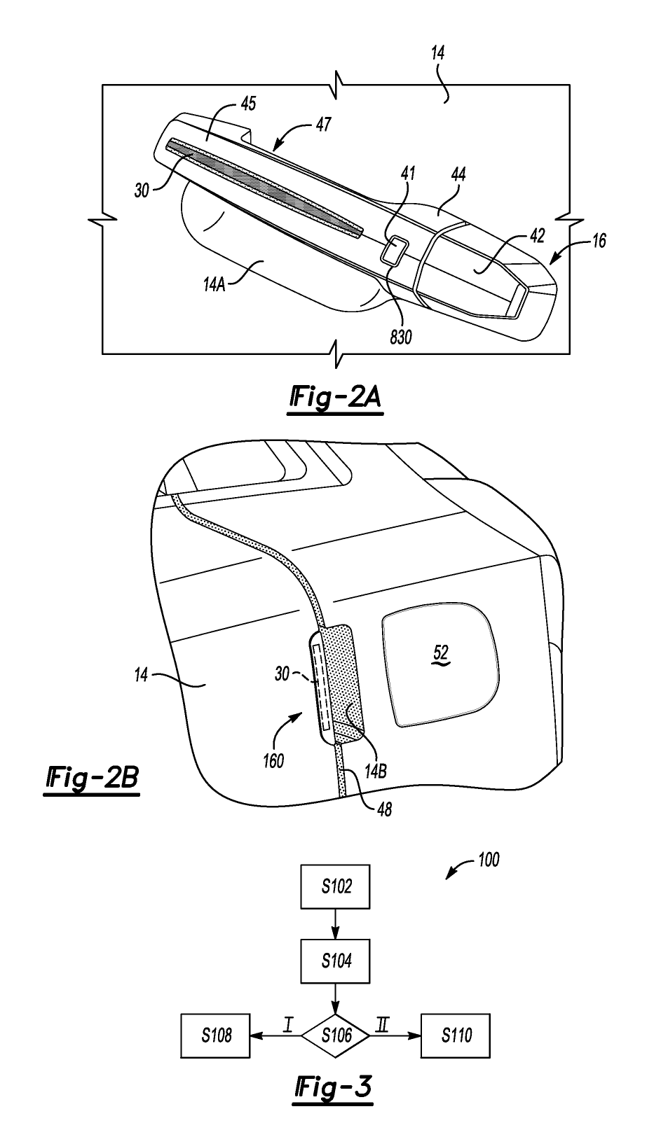

The controller 50 of FIG. 1 may be configured as one or more digital computers specially programmed to execute the instructions for method 100, an example of which is shown in flow chart form in FIG. 3. To that end, the controller 50 should include sufficient hardware to perform the required steps, i.e., the memory (M) and processor (P), as well as other hardware such as a high-speed clock, analog-to-digital and/or digital-to-analog circuitry, a timer, input/output circuitry and associated devices such as a transceiver (TR), and signal conditioning and/or signal buffering circuitry. The memory (M) includes sufficient tangible, non-transitory memory such as magnetic or optical read-only memory, flash memory, etc., as well as random access memory, electrically erasable programmable read only memory, and the like. In some vehicle embodiments, the controller 50 may be a vehicle body control module of the type known in the art.

Ingress and egress to and from the passenger compartment 13 shown in FIG. 1 may be achieved via actuation of a respective door handle 16 for a given door 14. The lighting device 30 and/or an alternative lighting device 830 may be positioned with respect to the door handle 16, that is, on, within, or adjacent to the door handle 16, with two possible designs depicted in FIGS. 2A and 2B. Another lighting device 130 may be positioned on the additional component 15, such as an available obstacle warning lamp and/or turn signal lamp integrated with a side mirror assembly as shown. Designated task lights of conventional multi-functional headlights 22, i.e., any lighting functions other than high-beam and low-beam functions, may be used in some embodiments as the lighting device 230. Additionally, the lighting device 130 and/or a lighting device 330 positioned with respect to the door 14, such as along the bottom of the door or near a door sill, may be configured to direct light (arrows L) toward and onto a road surface to achieve a projected light pooling effect.

Other placement options include that of the lighting device 430 on the A-pillar 17, or placement on the body 12 in proximity to a tire 25 of the vehicle 10, or on/near the deck lid 140 as the lighting devices 630 and 730, respectively, with the above-mentioned placement options being just some of the many possible locations on the vehicle 10. Those of ordinary skill in the art will also appreciate that the placement may be in the passenger compartment 15 as many interior positions remain visible from outside of the vehicle 10, for instance on a dashboard 23 or along upper surfaces of interior door or trim panels (not shown).

The vehicle 10 also includes a powertrain 28, which is shown schematically as an illustrative inset to FIG. 1. The powertrain 28 typically includes an engine (E) coupled to a transmission (T) via an input clutch C1, e.g., a friction clutch or a hydrodynamic torque converter. In some embodiments, an electric machine (M_{E}) may, alone or in conjunction with the engine (E), deliver input torque (arrow T_{I}) to the transmission (T). Output torque (arrow T_{O}) is ultimately delivered to drive axles to propel the vehicle 10. In some embodiments, the engine (E) may be omitted such that the input torque (arrow T_{I}) is provided solely via the electric machine (M_{E}).

As noted above, a status of the vehicle 10 is automatically determined by the controller 50 and displayed via the lighting device 30 or any of its possible embodiments. For simplicity, the lighting device 30 is used hereinafter to refer to any or all of the lighting devices 30, 130, 230, 330, 430, 530, 630, 730, and/or 830 shown in FIG. 1. As part of the present approach, a set of sensors 31 of the vehicle 10 are used to measure, detect, or otherwise determine the status that is ultimately indicated via the lighting device 30 and/or one of its alternative embodiments as part of the method embodied by the instructions 100.

In a possible design, the set of sensors 31 may include a powertrain sensor (S_{PT}) operable for detecting a powertrain status (arrow S₂₈), including an on/off ignition status of the powertrain 28. When the powertrain 28 includes the engine (E), such an on/off ignition status includes an active running status of the engine. However, the ignition status may be independent of the running status of the engine (E), such as in electric powertrains in which the engine is not a powertrain component or in hybrid electric vehicles in which the engine may not be running at idle. As noted below, the visual indication of such a running status or ignition status may be of value in electric powertrains or push-button start designs, as the engine (E) may at times be difficult to hear or omitted altogether from the powertrain design.

In another possible embodiment, the sensors 31 may include a door lock sensor (S₁₆) and/or a window position sensor (S₂₁). In such embodiments, the door lock sensor (S₁₆) is operable for detecting a locked/unlocked status (arrow L₁₆) of the particular door 14 to which the lighting device 30 is connected. Likewise, the window position sensor (S₂₁) is operable for detecting an open/closed position (arrow P₂₁) of the particular window 21 the lighting device 30 is positioned in proximity to. Similarly, a trunk position sensor S₁₄₀ can detect an open/closed position (arrow P₁₄₀) of the trunk lid 140 and communicate the same to the controller 50. Other possible options include the use of a turn signal/hazard light sensor S_{TS} or a battery sensor S_{B} respectively operable for detecting a turn signal or hazard light status (arrow 26) and a charging status/state of charge (arrow SOC) of a battery (not shown). The latter embodiment may be useful for monitoring ongoing charging of an electric or hybrid electric vehicle in a manner somewhat analogous to monitoring ongoing changes in tire pressure while filling a tire 25.

In yet another embodiment, the vehicle 10 may include tire pressure sensors (S₂₅) positioned with respect to one of the tires 25. The tire pressure sensors (S₂₅) measure and communicate individual tire pressures (arrow P₂₅) to the controller 50, as is known in the art. The controller 50 may be programmed to determine whether the measured tire pressure (arrow P₂₅) exceeds a calibrated threshold tire pressure, for instance a predetermined pressure value stored in memory (M) as a reference “fully inflated” pressure value, e.g., 35 PSIG. The status can be visually indicated via the lighting device 30 when tire pressure falls for a given tire 25 below the threshold tire pressure.

One possible way to do this is by illumination or activation of the particular lighting device 530 positioned adjacent the tire 25 whose pressure is low relative to the calibrated threshold tire pressure, and automatically deactivating the lighting device 530 when the tire 25 is sufficiently filled with air. Other sensors 31 and associated measurements may be envisioned within the intended inventive scope, such as a position of a sun roof (not shown) or of the hood 19. For the low tire pressure status, the lighting device 530 may change color when tire pressure is low relative to the threshold tire pressure, and may slowly change to a different color as tire pressure increases, e.g., by changing gradually from red to yellow to green before turning off at full pressure. Such color-changing control may be enabled when the ignition is off or the vehicle 10 is in park.

The controller 50 of FIG. 1 may receive the measured status from the set of sensor(s) 31 and then command illumination of the lighting device 30 in a particular manner when the remote device 20 is in a predetermined range or proximity of the vehicle 10. For an example key fob or other remote keyless entry device embodiment of the remote device 20, the controller 50 may be programmed to execute the method 100 only when the remote device 20 is within effective RF range of the vehicle 10, such that the status is not indicated when the operator of vehicle 10 is not sufficiently close to the vehicle 10. Optionally, the controller 50 may be programmed to provide an additional indication as the operator moves away from the vehicle 10, such as a quick sounding of a horn or flashing of the headlights when the operator approaches the range limit of the remote device 20. Such an option may be desirable, for instance, in conjunction with the ignition status to alert the operator that the ignition remains on or the engine (E) is still running. When the remote device 20 is a cell phone or other device, the range may vary from typical RF ranges without departing from the intended inventive scope.

Illumination, as that term is used herein, may include color-coding the light that is emitted by the lighting device 30 such that the emitted light has a color corresponding to the status. By way of a non-limiting example, when a door 14 or the trunk lid 140 is locked and the remote device 20 remains in its effective range of the vehicle 10, the lighting device 30 may emit red, amber, yellow, or another suitable color of light when the door 14 or trunk lid 140 is unlocked, and white, green, blue, or another color of light when the door 14 or trunk lid 140 is locked. In some designs the lighting device 30, particularly when connected to the door handle 16, may act as an additional side marker illuminated as a turn signal or as additional hazard lights, with the vehicle status in this instance being the turn signal or hazard light status. Likewise, the lighting device 30 may emit red, amber, or yellow light when tire pressure (arrow P₂₅) falls below the threshold tire pressure, and may simply turn off altogether when the tire pressure (arrow P₂₅) rises above the threshold tire pressure, or may flash briefly and then turn off depending on the embodiment.

In a particular design, illumination may be via a slow or rapid pulsation of light emitted by the lighting device 30. By way of an example, the controller 50 may be programmed to command a heartbeat-like pulsating of emitted light after a remote start event requested via the remote device 20, or when an operator exits the vehicle 10 and begins walking away. Such a feature may be desirable when used with relatively quiet electric or hybrid vehicles, with rapid blinking providing visual feedback when the trunk 140, the window 21, the door 14, or a sunroof (not shown) is left open, or blinking/flashing or color changing when tire pressure is too low relative to a suitable tire fill pressure threshold. An alarm status of this type could be accented via pulsation of an indication light 23L on the dashboard 23, such that status is visible from different viewing angles of the vehicle 10.

An indication light 23L typically located on the dashboard 23 could be retained or eliminated altogether in alternative designs. For example, when the doors 14 lock, the handle 16 could turn red, white, or another suitable color as noted above. After a typical delay, e.g., 20-30 seconds, an access detection alarm (S_{A}) may be activated in the usual manner, with the access detection alarm (S_{A}) outputting an active alarm status (arrow 34) when activated. At this point, the controller 50 can command the lighting device 30 to flash red once and then turn off. The existing indication light 23L would then periodically flash with low power consumption to indicate the active alarm status. However, one of ordinary skill in the art will appreciate that the lighting device 30 could perform this function. Such an embodiment could provide a possible cost savings by eliminating the existing indication light 23L from the dashboard 23 and allowing the lighting device 30 to serve as a more visible alarm status indicator, illuminating or quick-flashing with low power consumption in response to receipt of the active alarm status (arrow 34) by the controller 50.

Referring to FIGS. 2A and 2B, an example door handle 16 is depicted with respect to a door 14 having a surface indentation 14A facilitating grasping of the door handle 16 by the operator. In the style shown in FIG. 2A, the door handle 16 has a moveable section 44 and a fixed section 42, with the moveable bar section 44 having a front surface 45 and a rear surface 47. Entry into or egress from the vehicle 10 is achieved by pulling on the bar section 44 as is known in the art. The lighting device 30 may be embodied as an elongated, LED-driven light bar or light pipe that is coaxially aligned with the door handle 16 as shown. For instance, a red, green, blue (RGB) color-changing or color-selectable LED device of a type well known in the art may be arranged on a front surface 45 of the bar section 44, i.e., oriented away from the door 14.

Optionally, a keyless touch-sensitive unlock button 41 or a conventional key hole may be included in the structure of the door handle 16. When so equipped, the lighting device 830 may be used in conjunction with the button 41, with the lighting device 830 possibly embodied as a halo or ring surrounding the button 41 and/or otherwise illuminating the button 41. As an example embodiment, the lighting device 830 may be illuminated with a predetermined color when the door 14 is first unlocked and not illuminated, or illuminated in another suitable color, when the door 14 locked. The lighting device 830 may be the only indication of the locked/unlocked status of the door 14 in some embodiments, with the lighting device 30 that is located with respect to the moveable bar section 44 controlled to depict another vehicle status such as ignition on/off status.

FIG. 2B depicts an alternative configuration in which the door handle 160 is flush with the door 14. Such a design may be preferred in aerodynamic vehicles in which protrusion of door handle structure into the airstream is not desirable. In such an embodiment, e.g., a sport coupe in which the doors 14 are positioned adjacent to a fuel door 52, the lighting device 30 may be positioned within or behind the door handle 160 so that a surface indentation 14B is illuminated with a predetermined, status-based color or pulsing pattern. As shown, light may be visible in any gap or space 48 defined by the closed door 14 and adjacent portions of the body 12 to achieve for a desired lighting effect.

FIG. 3 depicts an example embodiment of the method 100 and begins with step S102, wherein an input signals each indicative of a status of the vehicle 10 are measured by the set of sensors 31 shown in FIG. 1. The method 100 proceeds to step S104 when the measured values indicative of the status, e.g., ignition on/off status, tire pressure, charging status, lock/unlock and/or position status of the doors 14, windows 21, trunk lid 140, etc., are received by the controller 50.

Step S104 also entails comparing the received measured values indicative of the status to calibrated thresholds and recording the result of such a comparison in memory (M). For instance, the memory (M) may include a pre-recorded tire pressure threshold, or alternatively an electrical charging status for electric or hybrid electric vehicle designs, while most of the other example statuses may have a binary state of 0 or 1 corresponding to an on/off, open/closed, running/not running status. The method 100 then proceeds to step S106.

At step S106, the controller 50 next determines whether the values from step S104 correspond to a first status (I) or a second status (II), with status (I) being low-pressure, an unlocked status, or an open position status in the above example status from step S104. Status (II) may be the opposite status, or sufficient tire pressure, a locked status, or a closed position, respectively. The method 100 proceeds to step S108 when status (I) is present and to step S110 when status (II) is present.

Step S108 includes detecting whether the remote device 20 is in a predetermined range of the vehicle 10, as noted above. If so, the controller 50 generates and transmits the output signals (arrow 11) of FIG. 1 to the lighting device 30 and/or its alternative embodiments in response to the remote device 20 being in the predetermined range. The output signals (arrow 11) may be a generated electrical control signal, for instance a control current or voltage signal, which requests, for status I, a strobing or pulsating of light at a predetermined frequency, an embodiment that may be desirable in particular for indication of an engine running/ignition on status. The output signals (arrow 11) may also or alternatively command illumination of the lighting device 30 with a specific color, with the color being indicative or representation of the status. Red, amber, yellow, or another suitable color can be used as a warning to show an unlocked, open, or low tire pressure status. Because color may be perceived differently by different viewers, or by the same viewer under different lighting conditions, the strobing function noted above, used alone or in conjunction with pre-programmed or user-selectable colors, may be useful in conveying the desired status information.

Step S110 includes detecting whether the remote device 20 is in a predetermined range of the vehicle 10, as noted above. If the remote device 20 is in the predetermined range, the controller 50 generates and transmits the output signals (arrow 11) of FIG. 1 in response to the determination of the second status (II) at step S106. The output signals (arrow 11) may command continuous/non-strobing illumination, particularly for an engine or ignition off status. As with step S108, the output signals may also or alternatively command illumination with a specific color, with the color indicative of the status. For instance, any color other than red can be used to show a locked, closed, or sufficient pressure status.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A vehicle comprising:
a powertrain;
a body;
a component connected to the body;
a tire;
a lighting device connected to the body or to the component that illuminates in response to an output signal in a manner corresponding to a status of the vehicle;
a sensor operable for determining the status of the vehicle; and
a controller having a processor and memory on which is recorded instructions for indicating the status of the vehicle via the lighting device, wherein execution of the instructions by the processor causes the controller to:
receive, from a remote device, a proximity signal indicative of an operator of the vehicle being within a predetermined range of the vehicle;
receive an input signal from the sensor indicative of the status of the vehicle, including at least one of an ignition status of the powertrain and a low tire pressure status of the tire; and
transmit the output signal to the lighting device in response to both the received input signal and the proximity signal to thereby command an illumination of the lighting device.

2. The vehicle of claim 1, wherein the status includes the ignition status.

3. The vehicle of claim 2, wherein the status also includes the low tire pressure status, and wherein the lighting device includes a first lighting device operable to indicate the ignition status and a second lighting device operable to indicate the low tire pressure status.

4. The vehicle of claim 3, wherein the component includes a door handle, and wherein the first lighting device is positioned on or within the door handle.

5. The vehicle of claim 4, wherein the sensor includes a turn signal or hazard light sensor operable for detecting a turn signal or hazard light status, and wherein the controller is further programmed to command an illumination of the lighting device in response to the turn signal or hazard light status.

6. The vehicle of claim 4, wherein the vehicle status includes a locked/unlocked status of a door to which the door handle is attached.

7. The vehicle of claim 6, wherein the door handle includes a fixed portion with a button or key hole, and wherein the first lighting device surrounds or directly illuminates the button or key hole.

8. The vehicle of claim 1, further comprising an access detection alarm having an active alarm status as the vehicle status, and wherein the first lighting device is periodically illuminated via the controller to display the active alarm status.

9. The vehicle of claim 1, wherein the body includes a trunk lid, the lighting device is positioned with respect to the trunk lid, and the status of the vehicle further includes an open/closed status of the trunk lid.

10. The vehicle of claim 1, wherein the commanded illumination includes a pulsation of light emitted by the lighting device when the ignition status is an on ignition status.

11. A method for indicating a status of a vehicle having a powertrain, a tire, a lighting device that illuminates in response to an output signal in a manner corresponding to a status of the vehicle, and a sensor operable for determining the status of the vehicle, the method comprising:
receiving an input signal from the sensor via a controller, wherein the input signal is indicative of the status of the vehicle, and wherein the status includes at least one of on/off ignition status of the powertrain and a low pressure status of the tire;
detecting whether a remote device is in a predetermined range of the vehicle;
transmitting the output signal to the lighting device in response to the received input signal only when the remote device is in the predetermined range; and
illuminating the lighting device in response to the transmitted output signal.

12. The method of claim 11, wherein the vehicle includes a door having a door handle, and wherein illuminating the lighting device includes illuminating a lighting device positioned with respect to the door handle.

13. The method of claim 12, wherein the vehicle includes an access detection alarm having an active alarm status, further comprising illuminating the lighting device to communicate the active alarm status.

14. The method of claim 11, wherein the vehicle includes a side mirror assembly as the component, and wherein illuminating the lighting device includes illuminating a lighting device positioned on or within the side mirror assembly.

15. The method of claim 11, wherein the body includes an A-pillar, and wherein illuminating a lighting device includes illuminating a lighting device that is positioned with respect to the A-pillar.

16. The method of claim 11, wherein receiving an input signal from the sensor further includes receiving a turn signal or hazard light status, and wherein illuminating the lighting device in response to the transmitted output signal includes illuminating the lighting device to communicate the turn signal or hazard light status.

17. The method of claim 11, wherein the status of the vehicle includes the ignition status, and illuminating the lighting device includes commanding a pulsation of light emitted by the lighting device when the ignition status is an on or active ignition status.

18. The method of claim 17, wherein receiving an input signal indicative of the status of the vehicle includes receiving a tire pressure signal from the sensor, and wherein the status includes the low tire pressure status.

19. The method of claim 11, wherein the lighting device includes a first lighting device operable to display the on/off ignition status and a second lighting device operable to display the low tire pressure status, and wherein the status includes the ignition status and the low pressure status.

20. The method of claim 11, wherein the lighting device is positioned on a door handle of the vehicle and the status of vehicle includes a locked/unlocked status of a door of the vehicle.
